(19) United States
(12) Patent Application Publication
(10) Pub. No.: US 2021/0175543 A1
(43) Pub. Date: Jun. 10, 2021

(54) REINFORCED COMPOSITE POLYMER ELECTROLYTE FOR FLEXIBLE LITHIUM ION SECONDARY BATTERY AND METHODE OF MANUFACTURING THE SAME

(71) Applicant: KOREA ADVANCED INSTITUTE OF SCIENCE AND TECHNOLOGY, Daejeon (KR)

(72) Inventors: Il-Kwon OH, Daejeon (KR); Saewoong OH, Daejeon (KR)

(21) Appl. No.: 17/113,592

(22) Filed: Dec. 7, 2020

(30) Foreign Application Priority Data
Dec. 10, 2019 (KR) 10-2019-0163543

(51) Int. Cl. H01M 10/0565; H01M 10/0525; C08F 214/28; C08F 214/22

(52) U.S. Cl. CPC H01M 10/0565; H01M 10/0525; H01M 2300/0091; C08F 214/22; H01M 2300/0082; C08F 214/28

(57) ABSTRACT

A method for manufacturing a reinforced composite polymer electrolyte comprises: manufacturing a porous thin film, impregnating the porous thin film with an electrolyte, and irradiating the impregnated porous thin film with ultraviolet rays.

The manufactured reinforced composite polymer electrolyte may maintain the electrochemical performance thereof while stably maintaining a structure thereof against mechanical deformation such as folding, bending and rolling, and can be used for a flexible lithium secondary battery.

### CROSS-REFERENCE TO RELATED APPLICATION

This application claims priority to and the benefit of Korean Patent Application No. 10-2019-0163543 filed in the Korean Intellectual Property Office on Dec. 10, 2019, the entire contents of which are incorporated herein by reference.

### BACKGROUND OF THE INVENTION

### (a) Field of the Invention

A reinforced composite polymer electrolyte for a flexible lithium secondary battery and a method of manufacturing the same are provided.

### (b) Description of the Related Art

With the development of technology, there is an increasing demand for electronic devices that can have various forms of deformation such as bending, rolling, and folding. Flexible displays, sensors, and the like have been actively developed. However, batteries used as a source of energy supply for such flexible devices include electrolytes vulnerable to mechanical deformation in flexible devices, and thus cannot be easily applied to flexible electronic devices.

Therefore, research and development have been conducted to maintain the electrochemical performance of the electrolyte while strengthening the low mechanical strength of the existing electrolyte.

The above information disclosed in this Background section is only for enhancement of understanding of the background of the invention, and therefore it may contain information that does not form the prior art that is already known in this country to a person of ordinary skill in the art.

Prior art documents are disclosed as follow:

(Patent Document 1) Korean Patent Application Laid-Open No. 2017-0142928

(Patent Document 2) Korean Patent No. 1,066,390.

### SUMMARY OF THE INVENTION

An exemplary embodiment has been made in an effort to provide an electrolyte having advantages of maintaining the electrochemical performance of a battery while stably maintaining a structure of the battery against mechanical deformation such as folding, bending and rolling, compared to existing polymer electrolytes.

An exemplary embodiment has also been made in an effort is to provide a manufacturing method having advantages of synthesizing a polymer electrolyte in a large amount in a short time compared to existing polymer electrolytes.

An exemplary embodiment has also been made in an effort to provide an environmentally-friendly manufacturing method.

In addition to the above objects, exemplary embodiments may be used to achieve other objects not specifically mentioned.

An exemplary embodiment provides a method for manufacturing a reinforced composite polymer electrolyte includes manufacturing a porous thin film, impregnating the porous thin film with the electrolyte, and irradiating the impregnated porous thin film with ultraviolet rays.

A main material for manufacturing the porous thin film may include poly(vinylidene fluoride) or poly(vinylidene fluoride-co-hexafluoropropylene), acetone, and water.

A mixing ratio of acetone to water may be a volume ratio of 98:2 to 90:10.

The concentration at which poly(vinylidene fluoride) or poly(vinylidene fluoride-co-hexafluoropropylene) is dissolved may be about 20 mg/ml to about 120 mg/ml based on the entire solution.

Ultraviolet rays may have a wavelength of about 310 nm to about 315 nm and an intensity of about 30 mW/cm² to about 40 mW/cm², and may be radiated for about 1 minute to about 5 minutes.

The electrolyte may include a cross-linking agent, a plasticizer, a lithium salt, and a polymer photoinitiator.

The cross-linking agent may include polyethylene glycol diacrylate, an acrylate-based monomer including polyethylene oxide, or both of them.

The plasticizer may include succinonitrile, 1-butyl-3-methylimidazolium bis(trifluoromethylsulfonyl)imide, 1-ethyl-3-methylimidazolium bis(trifluoromethylsulfonyl)imide, or a combination thereof.

The lithium salt may include lithium bis(trifluoromethanesulfonyl)imide), lithium hexafluorophosphate, lithium bis(oxalato)borate, or a combination thereof.

The polymer photoinitiator may include 2,2-dimethoxy-2-phenylacetophenone, 2-benzyl-2-(dimethylamino)-1-[4-(morpholino)phenyl]-1-butanone), 4,4′-bis(dimethylamino)benzophenone, or a combination thereof.

An exemplary embodiment provides a reinforced composite polymer electrolyte including a porous thin film used as a reinforcing material and an electrolyte with which the porous thin film is impregnated.

The porous thin film has a surface and a cross-section each having a porous structure, and pores may be continuously connected in a thickness direction thereof.

The porous thin film may include poly(vinylidene fluoride) or poly(vinylidene fluoride-co-hexafluoropropylene)

An exemplary embodiment provides a flexible lithium secondary battery according to an exemplary embodiment including a positive electrode and a negative electrode, and a reinforced composite polymer electrolyte disposed between the positive electrode and the negative electrode, and the reinforced composite polymer electrolyte includes a porous thin film used as a reinforcing material and an electrolyte with which the porous thin film is impregnated.

An exemplary embodiment of the present invention provides a mobile device including the above-described flexible lithium secondary battery.

An exemplary embodiment of the present invention provides an electronic device according to an exemplary embodiment including the above-described flexible lithium secondary battery.

According to an exemplary embodiment, the structure of the battery may be stably maintained against mechanical deformation such as folding, bending, and rolling by using the porous thin film as a backbone reinforcing material.

According to an exemplary embodiment, smooth conduction of lithium ions can be achieved and the electrochemical performance as the electrolyte may be maintained by uniformly impregnating the pores of the porous thin film with the electrolyte.

According to an exemplary embodiment, a large amount of a backbone porous thin films may be manufactured in a short time by a phase separation method.

According to an exemplary embodiment, a large amount of reinforced composite electrolytes may be manufactured in a short time by impregnating the thin film with the electrolyte and then irradiating the impregnated thin film with ultraviolet rays.

According to an exemplary embodiment, the electrolyte may be manufactured in an environmentally friendly manner without the use of organic solvents which are harmful to the human body.

According to an exemplary embodiment, the porous thin film may be applied to various engineering fields requiring nano-sized pores.

### BRIEF DESCRIPTION OF THE DRAWINGS

FIG. 1 is an SEM surface image of a polymer electrolyte including a porous thin film according to Example 1.

FIG. 2 is an SEM surface image photographed during the folding of a polymer electrolyte including the porous thin film according to Example 1.

FIG. 3 is a graph showing the ionic conductivity retention according to a change in the bending angle of the polymer electrolyte including a porous thin film according to Example 1.

### DETAILED DESCRIPTION OF THE EMBODIMENTS

Embodiments of the present invention will be described in detail with reference to the accompanying drawings such that those having ordinary skill in the art to which the present invention pertains can easily carry out the embodiments. As those skilled in the art would realize, the described embodiments may be modified in various different ways, all without departing from the spirit or scope of the present invention. In order to clearly describe the present invention, parts irrelevant to the description are omitted from the drawings, and the same drawing reference numerals are used for the same or similar constituent elements throughout the specification. Further, specific description of a well-known and publicly-known technology will be omitted.

Throughout the specification, unless explicitly described to the contrary, the word “comprise”, and variations such as “comprises” or “comprising”, will be understood to imply the inclusion of stated elements but not the exclusion of any other elements.

Throughout the specification, the meaning of flexible includes all the meanings of foldable, folding, bendable, bending, rollable, rolling and the like.

Then, a method for manufacturing a reinforced composite polymer electrolyte according to an exemplary embodiment will be described in detail.

A porous thin film formed of poly(vinylidene fluoride) or poly(vinylidene fluoride-co-hexafluoropropylene) as a main material is manufactured.

Poly(vinylidene fluoride) or poly(vinylidene fluoride-co-hexafluoropropylene) is dissolved in a solution in which acetone and water are mixed.

The mixing ratio of acetone to water may be a volume ratio of about 98:2 to about 90:10. Within such a range, the porosity of the porous thin film may be adjusted to a desired level.

The concentration at which poly(vinylidene fluoride) or poly(vinylidene fluoride-co-hexafluoropropylene) is dissolved may be about 20 mg/ml to about 120 mg/ml of the entire solution. Within such a range, the size of pores of the porous thin film may be adjusted to a desired level.

The manufactured porous thin film may have a thickness of about 50 μm to about 100 μm.

The manufactured porous thin film may be applied as a thin film which requires porosity in various electronic and electrical devices in addition to an electrolyte for a secondary battery. For example, a manufactured porous thin film may be applied to a solar cell, a fuel cell, a sensor, a driver, and the like.

Next, after the mixed poly(vinylidene fluoride) or poly(vinylidene fluoride-co-hexafluoropropylene) solution is applied onto a substrate, an evaporation time of about 5 to about 10 minutes elapses.

In such an evaporation process, a phase separation between the polymer and acetone and between the polymer and water occurs, so that a fine nanostructure having a porous form is formed.

Next, an electrolyte is manufactured by uniformly mixing a cross-linking agent, a plasticizer, a lithium salt, and a polymer photoinitiator.

The cross-linking agent, plasticizer, lithium salt, and polymer photoinitiator have similar polarities to each other and thus can be homogenously mixed without any harmful organic solvent during mixing. In addition, the polymer photoinitiator allows the polymerization process of the cross-linking agent to be activated by ultraviolet rays. For example, the cross-linking agent may include polyethylene glycol diacrylate, an acrylate-based monomer including polyethylene oxide, or both of them.

The plasticizer may include succinonitrile, 1-butyl-3-methylimidazolium bis(trifluoromethylsulfonyl)imide, 1 -ethyl-3-methylimidazolium bis(trifluoromethylsulfonyl)imide, or a combination thereof.

The lithium salt may include lithium bis(trifluoromethanesulfonyl)imide, lithium hexafluorophosphate, lithium bis(oxalato)borate, or a combination thereof.

The polymer photoinitiator may include 2,2-dimethoxy-2-phenylacetophenone, 2-benzyl-2-(dimethylamino)-1-[4-(morpholino)phenyl]-1-butanone, 4,4′-bis(dimethylamino)benzophenone, or a combination thereof.

Next, a gel-like electrolyte is manufactured by uniformly impregnating the electrolyte manufactured by mixing the components. Since such a gel-like electrolyte does not leak compared to a conventional electrolyte in a liquid state, the gel-like electrolyte does not have a risk of fire caused by the leakage of the electrolyte. However, when the conventional liquid electrolyte leaks out, there is a risk of fire.

Further, a conventional thin separation membrane is used for the electrolyte in a liquid state, and such a thin separation membrane is easily broken by mechanical deformation (folding and bending). However, since the gel-like electrolyte may have a reinforced composite form to reinforce the mechanical strength, a short circuit inside the battery, which is caused by breakage, can be prevented.

Next, a reinforced composite polymer electrolyte is finally obtained by irradiating the thin film impregnated with the electrolyte with ultraviolet rays.

The thin film impregnated with the electrolyte is irradiated with ultraviolet rays having a wavelength of about 310 nm to about 315 nm and an intensity of about 30 mW/cm² to about 40 mW/cm² for about 1 minute to about 5 minutes. Within the above wavelength range, the activity of a polymer photoinitiator added is maximized, so that a polymer acquisition rate caused by the polymerization process of the cross-linking agent can be maximized. When the polymer photoinitiator is activated by ultraviolet irradiation to cause a cross-linking reaction of the cross-linking agent, the cross-linking reaction may be carried out in a shorter time than a cross-linking reaction by heat. Furthermore, the cross-linking reaction by heat requires at least about 1 hour or more, but the cross-linking reaction by ultraviolet rays can achieve synthesis within up to about 5 minutes.

The manufactured reinforced composite polymer electrolyte may have a thickness of about 100 μm to about 150 μm.

According to the related art, the mechanical strength of an electrolyte is increased by adding a polymer having a high molecular weight within a range of 100,000 to 1,000,000 to the electrolyte. In such a case, the use of an organic solvent is required for uniform mixing of the polymer in the electrolyte, and it takes a long time for the reaction. Furthermore, the polymer added to increase the mechanical strength results in a decrease in the electrochemical performance of the electrolyte and the battery.

In contrast, according to an exemplary embodiment, as the mechanical strength is increased by using a porous thin film as a backbone reinforcing material, the electrochemical performance of the electrolyte and the battery may be maintained by impregnating the pores of the porous thin film with the electrolyte.

Further, according to an exemplary embodiment, a uniform mixture may be prepared without any addition of a harmful organic solvent, and an electrolyte may be manufactured in a short time by the phase separation technique and UV irradiation.

Then, the reinforced composite polymer electrolyte according to an exemplary embodiment will be described in detail.

The reinforced composite polymer electrolyte includes a porous thin film used as a reinforcing material and an electrolyte impregnated with which the porous thin film is impregnated.

The manufactured porous thin film has a surface and a cross-section each having a porous structure, and has a structural body in which pores are continuously connected in a thickness direction thereof. For example, in the porous thin film according to an exemplary embodiment, the porous structure may be maintained not only on the surface of the porous thin film but also in the thickness direction thereof.

However, in the case of a conventional porous thin film manufactured by electrospinning, pores can be seen only on the surface of the porous thin film, and the pores are not maintained in the thickness direction of the porous thin film.

The specific description of the porous thin film and the electrolyte is as described above, and thus will be omitted.

Then, a flexible lithium secondary battery according to an exemplary embodiment will be described in detail.

The flexible lithium secondary battery includes a positive electrode, a negative electrode, and a reinforced composite polymer electrolyte disposed between the positive electrode and the negative electrode.

Here, the reinforced composite polymer electrolyte includes a porous thin film used as a reinforcing material and an electrolyte impregnated with which the porous thin film is impregnated.

The specific description of the porous thin film and the electrolyte is as described above, and thus will be omitted.

The flexible lithium secondary battery according to an exemplary embodiment may be used for a mobile device.

Here, the mobile device includes a device which can be used in a movable form, and is a device which is operated by being supplied with power.

The flexible lithium secondary battery according to an exemplary embodiment may be used for an electronic device.

Here, the electronic device includes all forms of devices which are operated electrically and/or electronically by power supply, and is not limited to any particular form.

Hereinafter, the present invention will be described in more detail with reference to examples, but the following examples are merely examples of the present invention, and the present invention is not limited to the following examples.

### Example 1

Poly(vinylidene fluoride-co-hexafluoropropylene) having a molecular weight of about 445,000 g/mol is dissolved in a solution in which acetone and water was mixed at a ratio of about 95:5 at a concentration of about 40 mg/ml of the entire solution.

The mixed poly(vinylidene fluoride-co-hexafluoropropylene) solution is uniformly spread on a Teflon plate by bar-coating, followed by an evaporation process for about 5 minutes.

Polyethylene glycol diacrylate, succinonitrile, and lithium bis(trifluoromethanesulfonyl)imide are used as a cross-linking agent, a plasticizer, and a lithium salt, respectively, and the cross-linking agent, the plasticizer, and the lithium salt are mixed at a mass ratio of about 1:2:2. 2,2-dimethoxy-2-phenylacetophenone as a polymer photoinitiator is added to the above-described mixed solution in an amount of about 1 wt % based on polyethylene glycol diacrylate as a cross-linking agent, thereby manufacturing an electrolyte.

The manufactured porous thin film is impregnated with the electrolyte manufactured by mixing the components by a dip-coating method for about 5 minutes.

After the thin film impregnated with the electrolyte is disposed between two transparent PET films, a final reinforced composite polymer electrolyte is manufactured by irradiating the thin film with ultraviolet rays having a wavelength of about 312 nm and an intensity of about 35 mW/cm² for about 2 minutes.

### SEM Analysis

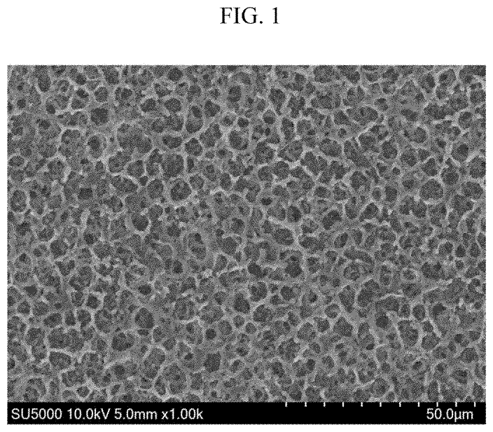

A SEM surface image photographed for the polymer electrolyte including the porous thin film according to Example 1 is illustrated in FIG. 1. Referring to FIG. 1, it can be seen that the porous thin film has a surface and a cross-section each having a porous structure, and has a structural body in which pores are continuously connected in the thickness direction thereof.

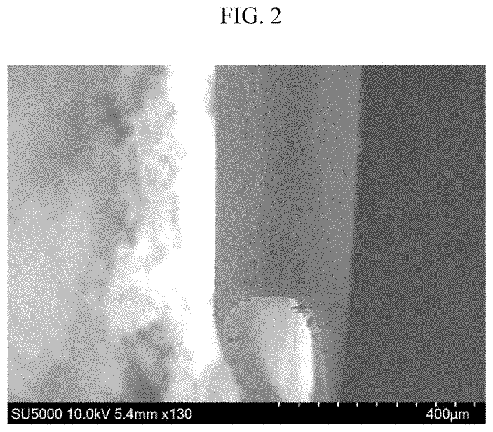

The SEM surface image photographed during folding of the polymer electrolyte including the porous thin film according to Example 1 is illustrated in FIG. 2. FIG. 2 shows that the mechanical strength of the polymer electrolyte is maintained even during folding thereof.

### Analysis of Electrochemical Characteristics of Electrolyte

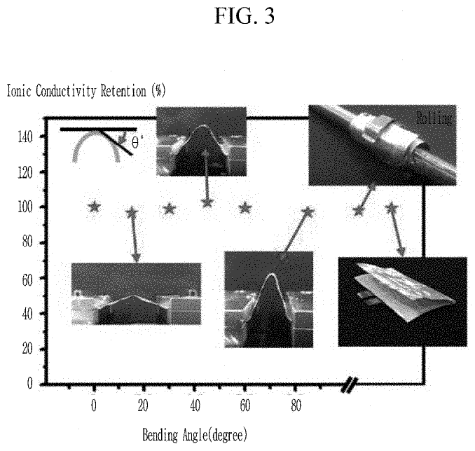

A graph showing the ionic conductivity retention according to a change in bending angle of the polymer electrolyte including the porous thin film according to Example 1 is illustrated in FIG. 3. Referring to FIG. 3, it can be seen that the electrochemical characteristics of the polymer electrolyte are maintained because the ionic conductivity is retained even in a bending state, a rolling state, and a folding state thereof (θ=180 degrees).

Although preferred exemplary embodiments of the present invention have been described in detail hereinabove, the right scope of the present invention is not limited thereto, and various modifications and improvements made by those skilled in the art using the basic concept of the present invention, which is defined in the following claims, also fall within the right scope of the present invention.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method for manufacturing a reinforced composite polymer electrolyte, the method comprising:
manufacturing a porous thin film,
impregnating the porous thin film with an electrolyte, and
irradiating the impregnated porous thin film with ultraviolet rays.

2. The method of claim 1, wherein:
a main material for manufacturing the porous thin film comprises poly(vinylidene fluoride) or poly(vinylidene fluoride-co-hexafluoropropylene), acetone, and water.

3. The method of claim 2, wherein:
a mixing ratio of the acetone to the water is a volume ratio of about 98:2 to about 90:10.

4. The method of claim 2, wherein:
a concentration at which the poly(vinylidene fluoride) or the poly(vinylidene fluoride-co-hexafluoropropylene) is dissolved is about 200 mg/ml to about 120 mg/ml based on the entire solution.

5. The method of claim 1, wherein:
the ultraviolet rays have a wavelength of about 310 nm to about 315 nm and an intensity of about 30 mW/cm² to about 40 mW/cm², and are radiated for about 1 minute to about 5 minutes.

6. The method of claim 1, wherein:
the electrolyte comprises a cross-linking agent, a plasticizer, a lithium salt, and a polymer photoinitiator.

7. The method of claim 6, wherein:
the cross-linking agent comprises polyethylene glycol diacrylate, an acrylate-based monomer comprising polyethylene oxide, or both of them.

8. The method of claim 6, wherein:
the plasticizer comprises succinonitrile, 1-butyl-3-methylimidazolium bis(trifluoromethylsulfonyl)imide, 1-ethyl-3-methylimidazolium bis(trifluoromethylsulfonyl)imide, or a combination thereof.

9. The method of claim 6, wherein:
the lithium salt comprises lithium bis(trifluoromethanesulfonyl)imide, lithium hexafluorophosphate, lithium bis(oxalato)borate, or a combination thereof.

10. The method of claim 6, wherein:
the polymer photoinitiator comprises 2,2-dimethoxy-2-phenylacetophenone, 2-benzyl-2-(dimethylamino)-1-[4-(morpholino)phenyl]-1-butanone, 4,4′-bis(dimethylamino)benzophenone, or a combination thereof.

11. The method of claim 1, wherein:
the porous thin film has a surface and a cross-section each having a porous structure, and pores are continuously connected in a thickness direction thereof.

12. A reinforced composite polymer electrolyte comprising:
a porous thin film used as a reinforcing material, and
an electrolyte with which the porous thin film is impregnated.

13. The reinforced composite polymer electrolyte
of claim 12, wherein:
the porous thin film has a surface and a cross-section each having a porous structure, and pores are continuously connected in a thickness direction thereof.

14. The reinforced composite polymer electrolyte of claim 13, wherein:
the porous thin film comprises poly(vinylidene fluoride) or poly(vinylidene fluoride-co-hexafluoropropylene).

15. The reinforced composite polymer electrolyte of claim 12, wherein:
the electrolyte comprises a cross-linking agent, a plasticizer, and a lithium salt.

16. A flexible lithium secondary battery comprising:
a positive electrode and a negative electrode,
a reinforced composite polymer electrolyte disposed between the positive electrode and the negative electrode,
wherein the reinforced composite polymer electrolyte comprises
a porous thin film used as a reinforcing material, and
an electrolyte with which the porous thin film is impregnated.

17. The flexible lithium secondary battery of claim 16, wherein:
the porous thin film has a surface surface and a cross-section each having a porous structure, and pores are continuously connected in a thickness direction thereof.

18. The flexible lithium secondary battery of claim 17, wherein:
the porous thin film comprises poly(vinylidene fluoride) or poly(vinylidene fluoride-co-hexafluoropropylene).
